(19) United States
(12) Patent Application Publication
(10) Pub. No.: US 2014/0052317 A1
(43) Pub. Date: Feb. 20, 2014

(54) METHOD FOR PREVENTING THEFT OF AN ELECTRIC VEHICLE AND AN ELECTRIC VEHICLE APPLYING THE SAME

(71) Applicant: KLEVER MOBILITY INC., New Taipei City (TW)

(72) Inventors: Kuang-Feng KO, New Taipei City (TW); Bow-Yi Jang, Taoyuan City (TW)

(73) Assignee: Klever Mobility Inc., New Taipei City (TW)

(21) Appl. No.: 13/891,525

(22) Filed: May 10, 2013

(30) Foreign Application Priority Data
Aug. 17, 2012 (TW) 101129977

(51) Int. Cl. B62H 5/08; B62H 5/18

(52) U.S. Cl. CPC B62H 5/08; B62H 5/18
USPC 701/22

(57) ABSTRACT

A method for preventing theft of an electric vehicle includes steps (a) and (b). In step (a), when a switch detector detects that the state of a main switch is an OFF state, and when a rotation detector detects that a drive wheel is rotating, a controller is configured to count a time period of rotation of the drive wheel. In step (b), the controller is configured to enable a locking mechanism for locking the drive wheel from rotation when the time period counted by the controller reaches a preset time period.

### CROSS-REFERENCE TO RELATED APPLICATION

This application claims priority to Taiwanese Application No. 101129977, filed on Aug. 17, 2012.

### BACKGROUND OF THE INVENTION

1. Field of the Invention

The present invention relates to a method for preventing theft of an electric vehicle and an electric vehicle applying the method.

2. Description of the Related Art

In recent years, due to environmental protection becoming an important issue, people started replacing gasoline motor vehicles with electric vehicles.

Referring to FIG. 1, a conventional vehicle 1 includes a vehicle body 11, a front wheel 12 and a rear wheel 13 spaced apart from each other and rotatably disposed on the vehicle body 11, a motor 14 for driving the rear wheel 13, a power supply 15 for providing the needed electric power to the motor 14, and a controller 16 electrically connected to the motor 14 and the power supply 15. The controller 16 controls the rotation speed of the motor 14 to control the movement speed of the electric vehicle 1.

However, theft is common for both electric vehicles and gasoline vehicles, and therefore the users of such vehicles often require appropriate locking devices to lock the parked vehicles in order to prevent theft of the vehicles.

Nevertheless, purchasing the locking devices requires extra expenditure and the locking devices may be intentionally damaged as they are mostly exposed on the exterior of the vehicles. Such locking devices also affect the vehicle aesthetically.

### SUMMARY OF THE INVENTION

Therefore, an object of the present invention is to provide a method for preventing theft of an electric vehicle, and an electric vehicle applying the method.

According to the present invention, there is provided an electric vehicle including a main switch, a switch detector for detecting a switch state of the main switch, an electric power source controlled by the main switch, a motor for converting electricity from the electric power source into a mechanical power output, a drive wheel driven by the mechanical power output of the motor, a rotation detector for detecting rotation of the drive wheel, a locking mechanism operable to lock the drive wheel from rotation, and a controller coupled to the switch detector, the electric power source, the motor, the rotation detector and the locking mechanism.

The method for preventing theft of the electric vehicle comprises the steps of:

a) when the switch detector detects that the state of the main switch is an OFF state, and when the rotation detector detects that the drive wheel is rotating, configuring the controller to count a time period of rotation of the drive wheel; and

b) configuring the controller to enable the locking mechanism for locking the drive wheel from rotation when the time period counted by the controller reaches a preset time period.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic diagram of a conventional vehicle;

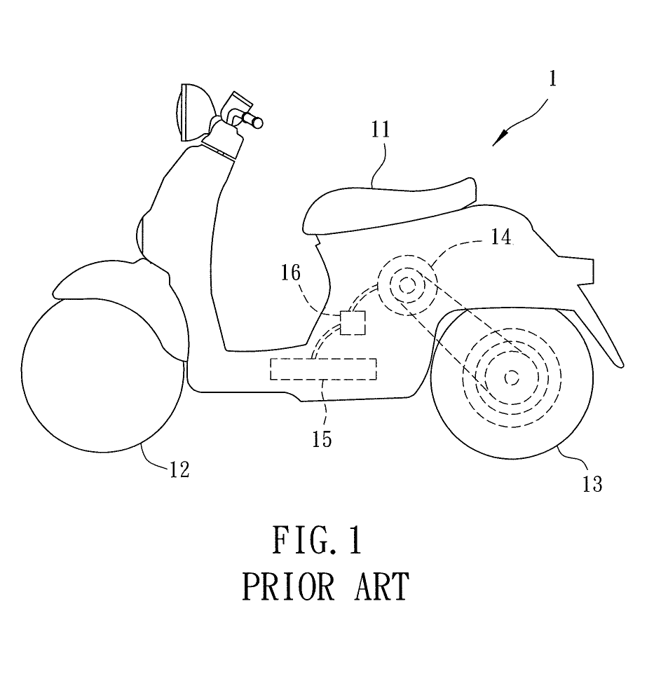

FIG. 2 is a schematic block diagram of the first preferred embodiment of an electric vehicle according to the present invention;

FIG. 3 is a flow chart of the method performed by the first preferred embodiment of an electric vehicle according to the present invention; and

FIG. 4 is a schematic block diagram of the second preferred embodiment of an electric vehicle according to the present invention.

### DETAILED DESCRIPTION OF THE PREFERRED EMBODIMENTS

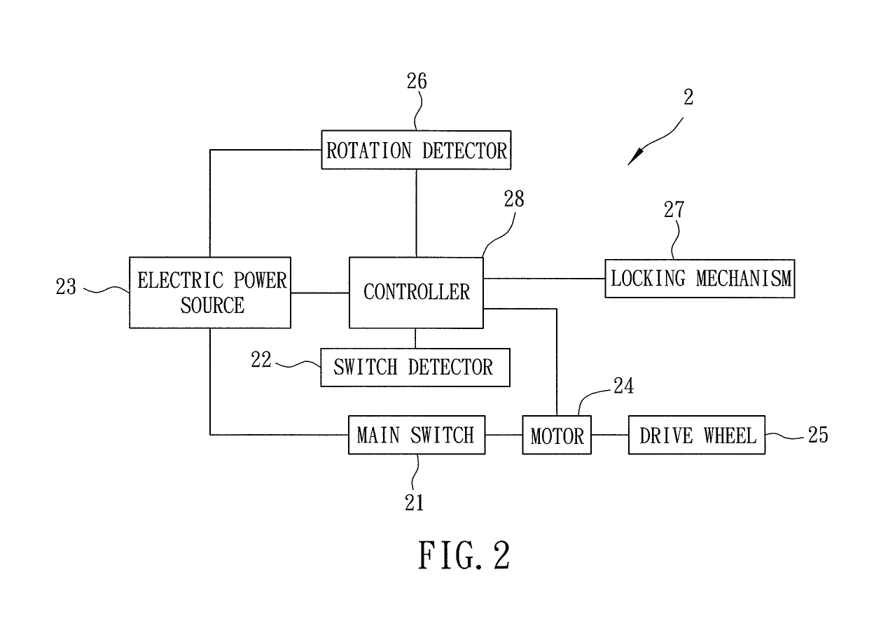

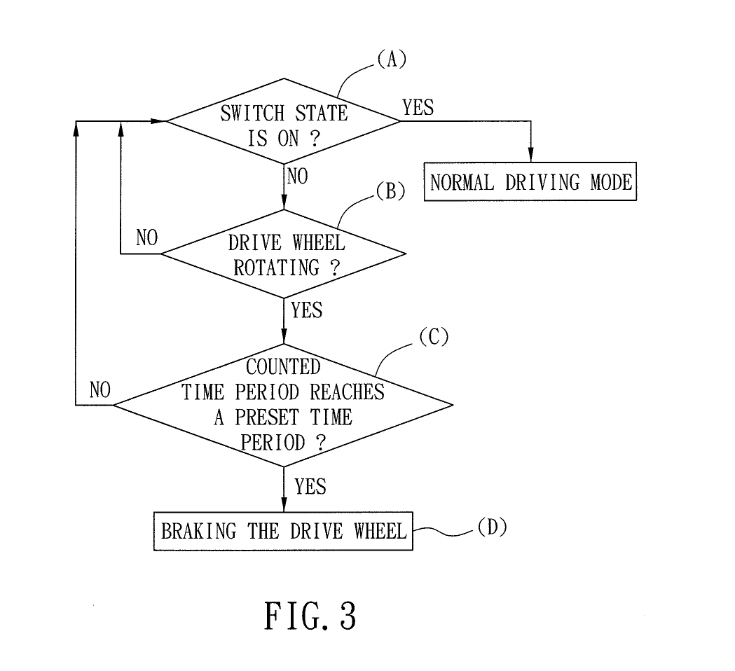

Referring to FIGS. 2 and 3, the first preferred embodiment of the method for preventing theft of an electric vehicle is applied to an electric vehicle 2. The electric vehicle 2 includes a main switch 21, a switch detector 22 for detecting a switch state of the main switch 21, an electric power source 23 controlled by the main switch 21, a motor 24 for converting electricity from the electric power source 23 into a mechanical power output, a drive wheel 25 driven by the mechanical power output of the motor 24, a rotation detector 26 for detecting rotation of the drive wheel 25, a locking mechanism 27 operable to lock the drive wheel 25 from rotation, and a controller 28 (such as a central processing unit) electrically coupled to the switch detector 22, the electric power source 23, the motor 24, the rotation detector 26 and the locking mechanism 27. The controller 28 also stores a program for implementing the method for preventing theft of an electric vehicle.

In this preferred embodiment, the electric power source 23 is a battery, the drive wheel 25 is a rear wheel of the electric vehicle 2, the rotation detector 26 is a Hall sensor that the motor 24 uses for rotation detection, and the locking mechanism 27 includes a plurality of power transistors electrically connected to the motor 24 and the electric power source 23.

When external forces are applied on the drive wheel 25, the motor 24 can be reversely driven, causing the motor 24 to produce back electromotive force. Therefore, the rotation detector 26 can also be a voltage comparator or a voltage switch that detects the back electromotive force produced by the rotation in the motor 24. The locking mechanism 27 can also be a brake that brakes the drive wheel 25.

The method for preventing theft of an electric vehicle includes step (A): detecting the state of the main switch 21. If the main switch 21 is in an OFF state, the controller 28 configures the electric power source 23 to enter a power saving mode, and the controller 28 performs step (B). In the power saving mode, the electric power source 23 only provides power to the rotation detector 26 and the controller 28, effectively minimizing power consumption. If the main switch 21 is in an ON state, it represents that the electric vehicle 2 is actuated by a vehicle owner using a vehicle key, and is not being stolen. Therefore, the electric vehicle 2 enters a normal driving mode, and the motor 24 operates using the electricity supplied from the electric power source 23.

Step (B) utilizes the rotation detector 26 to detect the rotation of the drive wheel 25. If the drive wheel 25 rotates but the main switch 21 is in an OFF state, the electric vehicle 2 is either being moved or stolen. At this moment, the rotation detector 26 sends a signal to wake up the controller 28 in the power saving mode and step (C) is then performed. If the drive wheel 25 is not rotating, then the electric vehicle 2 remains in the power saving mode and therefore step (A) is performed for the switch detector 22 to continuously detect for actuation of the main switch 21.

Step (C) configures the controller 28 to count if a time period of the rotation of the drive wheel 25 reaches a preset time period. If the counted time period reaches the preset time period, the electric vehicle 2 is moved a certain distance while the main switch 21 is not actuated. Possibly, the electric vehicle 2 is being stolen, and step (D) is performed next. If the counted time period does not reach the preset time period, the drive wheel 25 of the electric vehicle 2 did not rotate much. Possibly, the electric vehicle 2 is only moved a small distance and not being stolen, and therefore step (A) is performed next. In this preferred embodiment, the preset time period is one minute but should not be limited thereto.

In this preferred embodiment, the controller 28 counts the time period of rotation of the drive wheel 25 from the duration of the detected signal from the rotation detector 26.

Step (D) configures the controller 28 to control the locking mechanism 27 to brake the drive wheel 25, preventing the thief from pushing the electric vehicle 2 further. In this preferred embodiment, the controller 28 turns on two power transistors to brake the motor 24 in order to brake the drive wheel 25.

In this preferred embodiment, the method for preventing theft of an electric vehicle 2 configures, in step (B), the rotation detector 26 to detect the rotation of the drive wheel 25, configures, instep (C) the controller 28 to determine whether the duration of the detected signal from the rotation detector 26 reaches the preset time period, and configures, in step (D), the controller 28 to control the locking mechanism 27 to brake the motor 24 in order to brake the drive wheel 25. This method provides an internal anti-theft mechanism which is difficult for a thief to tamper with.

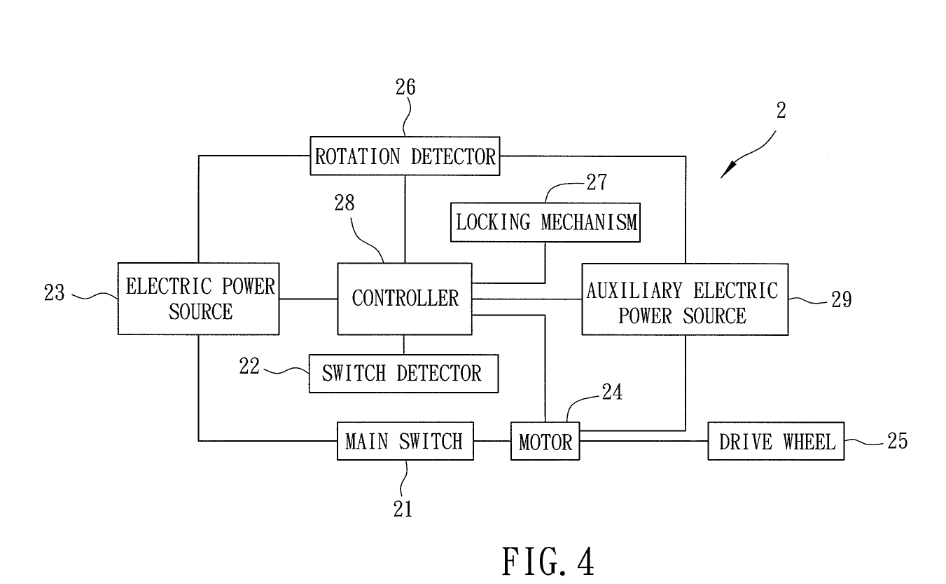

Referring to FIG. 4, a second preferred embodiment of the method of this invention is similar to the first preferred embodiment, with the differences being: the electric vehicle 2 further includes an auxiliary electric power source 29 electrically connected to the motor 24, the controller 28, and the rotation detector 26. The auxiliary electric power source 29 is charged by the back electromotive force of the motor 24, and provides electricity to the controller 28 and the rotation detector 26 when the electric power source 23 is unable to provide electricity.

Therefore, in the event that the electric power source 23 is depleted or stolen, the auxiliary electric power source 29 provides enough power for the controller 28 and the rotation detector 26 to maintain the anti-theft operation of the electric vehicle 2.

In summary, the method for preventing theft of an electric vehicle 2 configures, in step (B), the rotation detector 26 to detect the rotation of the drive wheel 25, configures, in step (C), the controller 28 to determine whether the duration of the detected signal from the rotation detector 26 reaches the preset time period, and configures, in step (D), the controller 28 to control the locking mechanism 27 to brake the motor 24 in order to brake the drive wheel 25. This method provides an internal anti-theft mechanism which is difficult for a thief to tamper with. Moreover, the components used in such electric vehicle 2 are common in any electric vehicle, and therefore the manufacturing cost can be effectively lowered.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method for preventing theft of an electric vehicle, the electric vehicle including a main switch, a switch detector for detecting a switch state of the main switch, an electric power source controlled by the main switch, a motor for converting electricity from the electric power source into a mechanical power output, a drive wheel driven by the mechanical power output of the motor, a rotation detector for detecting rotation of the drive wheel, a locking mechanism operable to lock the drive wheel from rotation, and a controller coupled to the switch detector, the electric power source, the motor, the rotation detector and the locking mechanism, the method comprising:
a) when the switch detector detects that the state of the main switch is an OFF state, and when the rotation detector detects that the drive wheel is rotating, configuring the controller to count a time period of rotation of the drive wheel; and
b) configuring the controller to enable the locking mechanism for locking the drive wheel from rotation when the time period counted by the controller reaches a preset time period.

2. method as claimed in claim 1, wherein the rotation detector detects rotation of the drive wheel by detecting rotation of the motor.

3. The method as claimed in claim 1, wherein the rotation detector detects rotation of the drive wheel by detecting back electromotive force generated by the motor.

4. The method as claimed in claim 1, wherein the locking mechanism is operable to lock rotation of the drive wheel by locking rotation of the motor.

5. The method as claimed in claim 1, wherein the locking mechanism is operable to lock rotation of the drive wheel by applying a braking force thereto.

6. An electric vehicle comprising:
a main switch;
a switch detector for detecting a switch state of the main switch;
an electric power source controlled by the main switch;
a motor for converting electricity from the electric power source into a mechanical power output;
a drive wheel driven by the mechanical power output of the motor;
a rotation detector for detecting rotation of the drive wheel;
a locking mechanism operable to lock the drive wheel from rotation; and
a controller coupled to the switch detector, the electric power source, the motor, the rotation detector and the locking mechanism;
wherein, when the switch detector detects that the state of the main switch is an OFF state, and when the rotation detector detects that the drive wheel is rotating, the controller is configured to count a time period of rotation of the drive wheel;
the controller being further configured to enable the locking mechanism for locking the drive wheel from rotation when the time period counted by the controller reaches a preset time period.

7. The electric vehicle as claimed in claim 6, wherein the rotation detector includes a Hall sensor for detecting rotation of the drive wheel by detecting rotation of the motor.

8. The electric vehicle as claimed in claim 6, wherein the rotation detector includes one of a voltage comparator and a voltage switch for detecting rotation of the drive wheel by detecting back electromotive force generated by the motor.

9. The electric vehicle as claimed in claim 6, wherein the locking mechanism is operable to lock rotation of the drive wheel by locking rotation of the motor.

10. The electric vehicle as claimed in claim 6, wherein the locking mechanism is operable to lock rotation of the drive wheel by applying a braking force thereto.

11. The electric vehicle as claimed in claim 6, further comprising an auxiliary electric power source coupled to the motor, the controller and the rotation detector, and operable to provide electricity to the controller and the rotation detector using back electromotive force generated by the motor.
